(19) United States
(12) Patent Application Publication
(10) Pub. No.: US 2008/0014503 A1
(43) Pub. Date: Jan. 17, 2008

(54) High power high voltage lithium-ion cell

(76) Inventor: Joseph B. Kejha, Meadowbrook, PA (US)

Correspondence Address: Zachary T. Wobensmith, III, 7746 101st Court, Vero Beach, FL, 32967-2871, US

(21) Appl. No.: 11/487,495

(22) Filed: Jul. 17, 2006

(51) Int. Cl. H01M 4/48; H01M 4/58; H01M 10/40

(52) U.S. Cl. 429/231.1; 429/231.5; 429/231.95; 429/332

(57) ABSTRACT

A high power high voltage lithium-ion cell, which includes an anode of lithium titanate (Li₄Ti₅0₁₂), a cathode of lithium cobalt phosphate (LiCoPO₄), and a non-aqueous liquid electrolyte. Both the anode and the cathode materials are preferably of nano-sized particles.

### CROSS REFERENCE TO RELATED DOCUMENTS

The subject matter of this invention is shown and described in the disclosure document of Joseph B. Kejha, document no. 557,375 filed Jul. 19, 2004, and entitled “High Power Lithium-ion Cell Having High Voltage”.

### BACKGROUND OF THE INVENTION

1. Field of the Invention

This invention relates to a high power high voltage lithium-ion cell, which is of the type that has a lithium titanate (Li₄ Ti₅0₁₂) anode, a liquid electrolyte, and a lithium cobalt phosphate (LiCoPO₄) cathode.

2. Description of the Prior Art

It is well known in the prior art that lithium titanate (Li₄Ti₅0₁₂) has excellent high rate capabilities (power), when used in lithium-ion batteries or in asymmetric capacitors. U.S. Pat. No. 5,766,796 discusses the use of lithium titanate as an anode, with a solid polymer electrolyte, and various cathodes, such as LiMn₂0₄, LiCo0₂, LiNi0₂ and LiV₂0₅ and their derivates. All of these electrochemical couples have a lower voltage span (1.5V-2.8V) than standard lithium-ion batteries with carbon anodes (3.0V-4.2V), which results in lower energy density.

It is therefore desirable to couple a lithium titanate anode with a high voltage cathode to obtain a lithium-ion cell with higher voltage and higher energy density.

Lithium cobalt phosphate (LiCoPO₄) is known as a cathode material with a high voltage potential of about 5 volts. Lithium cobalt phosphate has been tried as a cathode in lithium-ion cells coupled with anodes of graphite, MCMB, or lithium, however the cells failed due to the instability of the electrolyte, which oxidized due to the high voltage produced by the lithium cobalt phosphate cathodes. Prior art U.S. Pat. Nos. 5,910,382 of Goodenough et al and 6,514,640 B1 of Armand et al., in Example 1 states, that Li extraction (cell testing), was not possible due to the voltage being above 4.3 volts. Therefore the use of this material can not be claimed

Coupling a lithium titanate anode with a lithium cobalt phosphate cathode causes a voltage reduction to approximately 3.5 volts, resulting in a voltage span of (1.5V to 3.5V), approximately. A liquid non-aqueous electrolyte of well known type is used in the cell, and will not oxidize or decompose upon cycling.

### SUMMARY OF THE INVENTION

Now it has been found, that novel high power and higher voltage lithium-ion cells can be produced by coupling a lithium titanate anode with a lithium cobalt phosphate cathode in the presence of a liquid electrolyte, and with a separator therebetween.

The principal object of the invention is to provide a lithium-ion cell that has both high power and high energy density.

A further object of the invention is to provide a lithium-ion cell that is simple and inexpensive to construct.

A further object of the invention is to provide a lithium-ion cell wherein the anode and the cathode are fabricated of nano-sized particles.

A further object of the invention is to provide a lithium-ion cell, which is durable and has long lasting service.

A further object of the invention is to provide a lithium-ion cell, which is suitable for use in hybrid electric vehicles.

A further object of the invention is to provide a lithium-ion cell which is particularly suitable for mass production.

Other objects and advantageous features of the invention will be apparent from the description and claims.

It should, of course, be understood that the description herein is merely illustrative, and that various modifications and changes can be made in the structures disclosed without departing from the spirit of the invention.

### DESCRIPTION OF THE PREFERRED EMBODIMENT

When referring to the preferred embodiment, certain terminology will be utilized for the sake of clarity. Use of such terminology is intended to encompass not only the described embodiment, but also technical equivalents, which operate and function in substantially the same way to bring about the same result.

The lithium-ion cell of the invention can be of any desired configuration, in that it can be flat such as described in my prior U.S. patent application Ser. No. 11/378,973 or it can be wound, as is well known in the prior art.

The cell includes a first layer (not shown) which may be an anode with a porous current collector (not shown) embedded in the middle of its active material and with a terminal (not shown) extending therefrom. The anode includes lithiated titanium spinel (Li₄Ti₅0₁₂), which anode material may be produced by the method as disclosed in U.S. Pat. No. 5,766,796 wherein the anode consists of lithiated titanium spinel, preferably of nano-sized particles mixed with a high surface area carbon (such as acetylene black) and a polymeric binder. The anode has a metal current collector (not shown) with a terminal tab (not shown). A second electrode layer (not shown) is provided on top of the first layer, which may be a microporous separator of polytetrafluorethylene, as manufactured by W.L. Gore & Assoc., Inc. Elkton, Md.

The electrolyte can be any suitable electrolyte, with a 1 Mol LiPF₆/EC/DMC/EMC electrolyte in a ratio of (1:1:1) being particularly suitable, where EC=Ethylene Carbonate, DMC=Dimethyl Carbonate, and EMC=Ethyl-Methyl Carbonate.

A third electrode layer (not shown) is provided on top of the second layer, which layer is a cathode, and which may have a metal grid current collector (not shown) embedded therein. The cathode contains lithium cobalt phosphate (LiCoPO₄) which is preferably of nano-sized particles which are preferably milled and mixed with electrically conductive carbon or other suitable materials, and which cathode also contains a polymeric binder of well known type. The current collector (not shown) has a terminal tab (not shown) extending therefrom.

The cell (not shown) is preferably assembled as described in my prior U.S. patent application Ser. No. 11/378,973, by heat and pressure, with the various layers bonded together.

The cell (not shown) is then sealed in a suitable enclosure (not shown).

The higher voltage of this new electrochemical couple than the voltage of prior art couples, such as lithium titanate-lithium cobaltate; lithium titanate-lithium manganate; lithium titanate-lithium nickeltate; or lithium titanate-lithium vanadate, increases the energy density of the high power cells. The cobalt component in the LiCoP04 also provides for good stability upon cycling. The cost is also reduced by less cobalt presence as % (percent) of weight of this material as compared to LiCo0₂. Therefore a primary application of the described cell of the invention is for use in hybrid electric vehicles.

It will thus be seen that a lithium-ion cell has been provided with which the objects of the invention are achieved.

I claim:

1. A high power high voltage lithium-ion cell which comprises;
an anode which includes lithium titanate (Li₄Ti₅0₁₂),
a cathode of lithium cobalt phosphate (LiCoPO₄), and
a non-aqueous electrolyte.

2. A lithium-ion cell as defined in claim 1 in which
said lithium titanate and said lithium cobalt phosphate are of nano-sized particles.

3. A lithium-ion cell as defined in claim 1, in which
said electrolyte is one Mol LiPF₆/EC/DMC/EMC.

4. A lithium cell as defined in claim 3 which
has a ratio of carbonates of (1:1:1).
